(19) United States
(12) Patent Application Publication
(10) Pub. No.: US 2025/0379390 A1
(43) Pub. Date: Dec. 11, 2025

(54) Connector Plugs

(71) Applicant: NINGBO SEETRONIC ELECTRONIC TECHNOLOGY CO.. LTD., Ningbo (CN)

(72) Inventors: Junnan Ma, Ningbo (CN); Limin Xu, Ningbo (CN)

(73) Assignee: NINGBO SEETRONIC ELECTRONIC TECHNOLOGY CO.. LTD., Ningbo (CN)

(21) Appl. No.: 19/204,115

(22) Filed: May 9, 2025

(30) Foreign Application Priority Data
Jun. 7, 2024 (CN) 202410737326.6

(51) Int. Cl. H01R 13/502

(52) U.S. Cl. CPC H01R 13/502

(57) ABSTRACT

A connector plug includes a connector housing and a tail housing. The connector housing's rear end and the tail housing are threaded connected. The upper surface of the connector housing is provided with a threaded sleeve locking member matched with the tail sleeve and a mounting slot hole for the threaded sleeve locking member to stay in and slide back and forth. The front side of the tail sleeve is provided with a tooth opening along the circumference, and the rear end of the threaded sleeve locking member is provided with a one-way lock catch which is meshed with the tooth opening and enables the tail sleeve to rotate only in one direction and be fastened to the connector housing. An elastic piece is arranged in the mounting slot hole to enable the threaded sleeve locking member to maintain a backward movement trend to lock the tail sleeve.

### CROSS-REFERENCE TO RELATED APPLICATION

This application claims priority to Chinese Patent Application No. 202410737326.6, filed on Jun. 7, 2024, the disclosure of which is hereby incorporated by reference in its entirety.

### TECHNICAL FIELD

The present application relates generally to the technical field of connectors, and more specifically relates to a connector plug that facilitate secure installation and is safe to use.

### BACKGROUND

A connector is a connecting device for sequentially connecting a plurality of signal wires or power wires together. It is widely applied to various electric circuits and enables easy connecting or disconnecting the circuits. The structure of a connector generally comprises a housing and a tail sleeve, and the rear end of the housing is connected to the tail sleeve. The existing connector housing and the tail sleeve are mostly connected and fixed through a threaded structure. After the connector is assembled, the tail sleeve is kept in installation tightness degree by means of a threaded locking force, and the tail sleeve can be unscrewed by hands in a vibrating environment or after aging. Thus, when the connector is in use in a large voltage and/or large current environment, potential safety hazards exist.

In prior art, for example, CN202222286856.2, a connector plug comprises a plug shell, a tail sleeve and a key. An installation groove for a sliding part to be placed in and move back and forth is formed in the axial direction of the upper end face of the middle part of the plug shell. A through hole for the front end of the sliding part to extend out is formed in the front end of the installation groove, and the front end of the sliding part extends out of the installation groove to form a locking part matched and locked with a corresponding socket/plug. The rear end of the sliding part extends upwards to form a bevel and bends forwards to form a claw part matched and connected to the key. A reset spring is supported between the inner wall of the rear end of the installation groove and the rear end of the sliding part. The key is arranged in the installation groove and is positioned above the sliding part. The rear end of the key is hinged with the rear end of the installation groove, the front end of the key is bent to form a clamping hook part matched and abutted with the claw part, and the upper end of the key is provided with a key sleeve which is sleeved with the installation groove in a sealing way. This structure is waterproof and the button does not easily fall out. However, the tail sleeve in the prior art connectors still has to be unscrewed bare-handed and therefore is a potential safety hazard as well.

### SUMMARY

The present disclosure aims to solve the technical problems of providing a connector plug that is well structured, convenient to operate and safe to use, compared to the current state of the art. A threaded sleeve locking member is introduced so that the tail sleeve is not easy to unscrew by hand, reducing the risks caused by manual operation and loosening over time.

The technical solution adopted for solving the technical problems is as follows: a connector plug includes a connector housing and a tail housing. The connector housing's rear end and the tail housing are threaded connected. The upper surface of the connector housing is provided with a threaded sleeve locking member matched with the tail sleeve. The upper surface of the connector housing is provided with a mounting slot hole for the threaded sleeve locking member to stay in and slide back and forth. The front side of the tail sleeve is provided with a tooth opening along the circumference, the rear end of the threaded sleeve locking member is provided with a one-way lock catch which is meshed with the tooth opening and enables the tail sleeve to rotate only in one direction and be fastened with the connector housing. An elastic piece is arranged in the mounting slot hole to enable the threaded sleeve locking member to always maintain a backward movement trend to lock the tail sleeve.

In some embodiments, a spigot is arranged in the mounting slot hole. A locking point matched with the spigot is convexly arranged on the lower surface of the threaded sleeve locking member. When the locking point of the threaded sleeve locking member is matched with the spigot for locking, the threaded sleeve locking member is separated from the tail sleeve, and a key capable of separating and resetting the threaded sleeve locking member from the spigot is arranged above the threaded sleeve locking member by the connector housing. Therefore, a tool is not required to be always propped against the threaded sleeve locking member so that the threaded sleeve locking member is convenient to operate and use.

Further, the threaded sleeve locking member may be in a bar shape, and the key can be arranged above the threaded sleeve locking member in a front-back limiting sliding manner. The one-way lock catch at the rear end of the threaded sleeve locking member extends out of the key and is positioned at the front side of the external thread of the connector housing. An elastic piece is supported between the front end of the threaded sleeve locking member and the inner wall of the key, so that the threaded sleeve locking member maintains a trend of always moving backwards and stay meshed with the tail sleeve, making the operation convenient.

In one embodiment, the mounting slot hole comprises a bar slot or a bar hole or a combination thereof.

Still further, the front portion of the mounting slot hole may be the bar hole, and the rear portion may be the bar groove, both connected to form the connector plug, making it convenient to select a position and installing the threaded sleeve locking member and elastic piece at the selected position, thus difficult to deviating from the selected position.

In some embodiments, the key's front end is the locking piece, which cooperates with the socket locked groove of connector, and the internal surface of the top part of the key has a direction spout, which cooperates with the locking block that is located above the bar hole of the connector housing, preventing the key from slipping for convenient operation uses.

Preferably, the one-way lock catch is of a ratchet-shaped back-off structure, and the tooth opening at the front end of the inner wall of the tail sleeve is of a correspondingly matched triangular structure. The upper surface of the threaded sleeve locking member is convexly provided with a supporting block, making it convenient for pushing the threaded sleeve locking member to move forward on the front side of the one-way lock catch, so that a tool can conveniently prop against the threaded sleeve locking member.

Further, the upper surface of the threaded sleeve locking member is configured with a concave surface behind the supporting block, and a three-dimensional arrow mark is disposed on the concave surface for forward pushing. The tool remains pressing against the threaded sleeve locking member, making it difficult to slip off.

Still further, the longitudinal section of the spigot is triangular, and the longitudinal section of the locking point of the lower surface of the threaded sleeve locking member is inverted triangular. When the locking point of the threaded sleeve locking member is matched with the spigot for locking, the rear end of the threaded sleeve locking member is disengaged from the front end tooth opening of the tail sleeve, so that the threaded sleeve locking member is convenient to operate and use.

Finally, the tooth openings are disposed on the inner wall of the tail sleeve and the front part of the internal thread, making the structure well-constructed and aesthetically pleasing.

Compared with the prior art, the connection plug disclosed herein has the following advantages: the threaded sleeve locking member is arranged on the upper surface of the rear part of the connector housing; the tooth opening matched with the one-way lock catch of the threaded sleeve locking member is arranged on the front side of the internal threaded hole of the tail sleeve; when the connector housing is threaded connected to the tail sleeve and the one-way lock catch is meshed with the tooth opening after the tail sleeve is fastened to a certain position, the tail sleeve can only be tightened and cannot be loosened, so that the tail sleeve is prevented from being loosened by bare hands, and the connection stays tight and stable. The connection plug disclosed herein is well constructed. The tail sleeve is not easy to be unscrewed by hands due to the additionally arranged threaded sleeve locking member, thus avoiding the risks of manual operation and accidental loosening. The connection plug is convenient to reset, effectively ensures the safety and stability of the product use, and prolongs the service life of the product.

### BRIEF DESCRIPTION OF DRAWINGS

FIG. 1 is a schematic structural view of a connector plug according to an embodiment of the present application;

FIG. 2 is a cross-sectional view of a connector plug according to an embodiment of the present application;

FIG. 3 is a schematic view of the structure of FIG. 1 in a tail sleeve separated state;

FIG. 4 is a cross-sectional view of FIG. 3;

FIG. 5 is a cross-sectional view of an embodiment of the present application in a tail sleeve locked condition;

FIG. 6 is a cross-sectional view of an embodiment of the present invention in a state where the threaded sleeve locking member reaches the spigot and the tail sleeve is disengaged.

### DETAILED DESCRIPTION

The connector plug is described in further detail below with reference to the embodiments of the drawings.

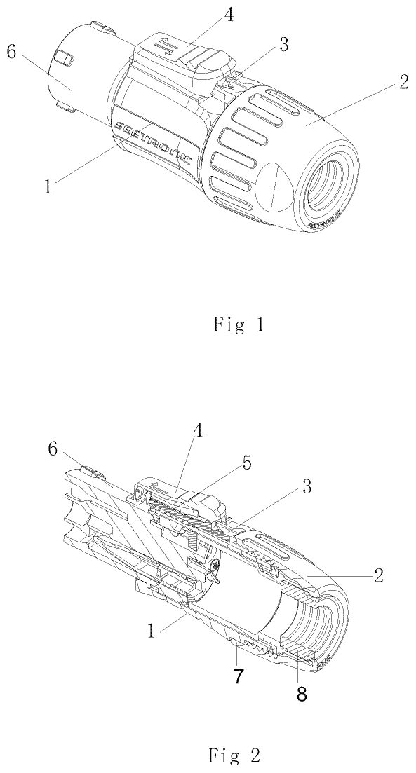

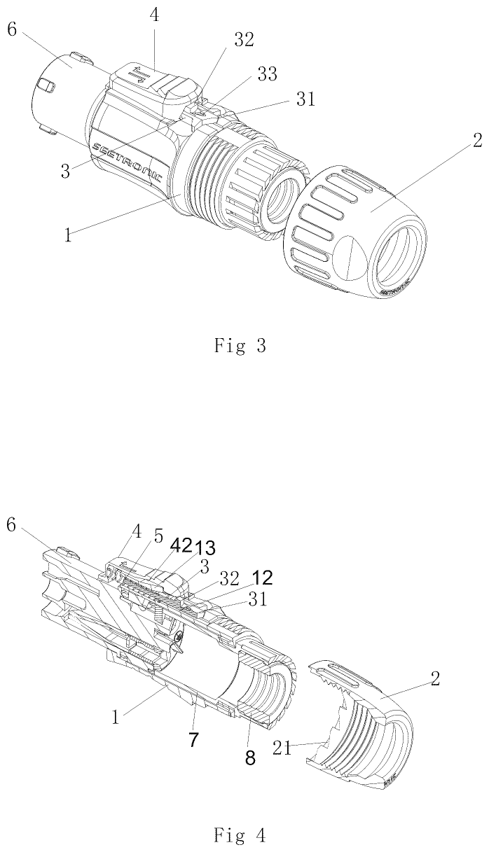

As shown in FIGS. 1 to 6, a connector plug comprises a connector housing 1 and a tail sleeve 2. The rear end of the connector housing 1 is in threaded connection with the tail sleeve 2. A threaded sleeve locking member 3 matched with the tail sleeve 2 is disposed on the upper surface of the connector housing 1, a mounting slot hole 12 is formed on the upper surface of the connector housing 1 for the threaded sleeve locking member 3 to be placed in and slide back and forth. A tooth opening 21 is formed on the inner wall of the tail sleeve 2. In the front side of an internal thread along the circumference, a one-way lock catch 31 is meshed with the tooth opening 21, enabling the tail sleeve 2 to rotate unidirectionally and be screwed to the connector housing 1. The one-way lock catch 31 is arranged at the rear end of the threaded sleeve locking member 3. A spring 5 such as an elastic member is arranged in the mounting slot hole 12, so that the threaded sleeve locking member 3 always maintains a backward movement trend to lock the tail sleeve 2.

As a further improvement and for convenient use, a spigot 11 is arranged in the mounting slot hole 12, and a locking point 34 matched with the spigot 11 is convexly arranged on the lower surface of the threaded sleeve locking member 3. When the locking point 34 of the threaded sleeve locking member 3 is matched and locked with the spigot 11, the threaded sleeve locking member 3 is separated from the tail sleeve 2. A key 4 capable of separating and resetting the threaded sleeve locking member 3 from the spigot 11 is disposed above the threaded sleeve locking member 3 in the connector housing 1, so that the locking point 34 is easy to buckle or separate. When the locking point 34 of the threaded sleeve locking member 3 is matched and locked with the spigot 11, a tool is not required to always be propped against the threaded sleeve locking member 3, making operation convenient.

An example structure of the connector plug is as follows: the threaded sleeve locking member 3 is of a bar shape, and the mounting slot hole 12 can adopt a bar-shaped groove or a bar-shaped hole or a combination of thereof. In this example, the mounting slot hole 12 adopts a combination form. The front part of the mounting slot hole 12 is the bar-shaped hole 12a, and the rear part is the bar-shaped groove 12b. The bar-shaped groove 12b is connected to the front part so that it is convenient to arrange and install the spring 5 and the threaded sleeve locking member 3. The edges of the threaded sleeve locking member 3 are arranged on two sides of the bottom surface of the key 4. The connector housing 1 is provided with matched sliding grooves on two sides forming the bar-shaped hole 12a. The key 4 can be arranged above the threaded sleeve locking member 3 in a front-back limit sliding manner through the matching of the edges and the sliding grooves. The one-way lock catch 31 at the rear end of the threaded sleeve locking member 3 extends out of the key 4 and is positioned on the front side of an external thread of the connector housing 1. The spring 5 is supported between the front end of the threaded sleeve locking member 3 and the inner wall of the key 4. The threaded sleeve locking member 3 has a tendency of always engaging with the tail sleeve 2. The front end of the key 4 is provided with a locking piece 41 matched with a socket locking groove of a connector. The inner surface of the top part of the key 4 is provided with a direction spout 42. The key 4 is matched with a locking block 13 positioned above the front part of the bar-shaped hole 12a of the connector housing 1 and is prevented from sliding. The one-way lock catch 31 adopts a ratchet-shaped back-off structure, and the back-off included angle of the one-way lock catch 31 is approximately 50-75°. The tooth opening 21 at the front end of the inner wall of the tail sleeve 2 is of a right triangle structure which is correspondingly matched. The upper surface of the threaded sleeve locking member 3 is protruding from the anterior side of the one-way lock catch 31 and is equipped with the supporting block 32 to promote the threaded sleeve locking member 3's forward movement. The upper surface of the threaded sleeve locking member 3 is equipped with a triangle-shaped concave surface on the rear side of supporting block 32, and is equipped with the three-dimensional forward-pushing arrow mark 33 on the concave surface. The longitudinal section of the spigot 11 is preferably triangular, and the longitudinal section of the locking point 34 on the lower surface of the threaded sleeve locking member 3 is preferably inverted triangular, so that the locking point 34 is convenient to buckle in or separate. When the locking point 34 of the threaded sleeve locking member 3 is matched and locked with the spigot 11 of the mounting slot hole 12, the rear end of the threaded sleeve locking member 3 is separate from the tooth opening 21 on the inner wall of the front end of the tail sleeve 2, so that the tail sleeve 2 can be tightened or untightened conveniently.

The front end is equipped with an inner core assembly 6 in the connector housing 1, and the inner core assembly 6 is a function piece by design. The rear end of the inner core assembly 6 is connected to a cable or signal line, overlaps with the double-layered cable jacket 7 and the sealing washer 8 as well. The through-hole that supplies cable or signal line is offered at the rear end of the tail sleeve 2. Finally, the tail sleeve 2 and the connector housing 1 are threaded connected.

An example operation process goes as follows:

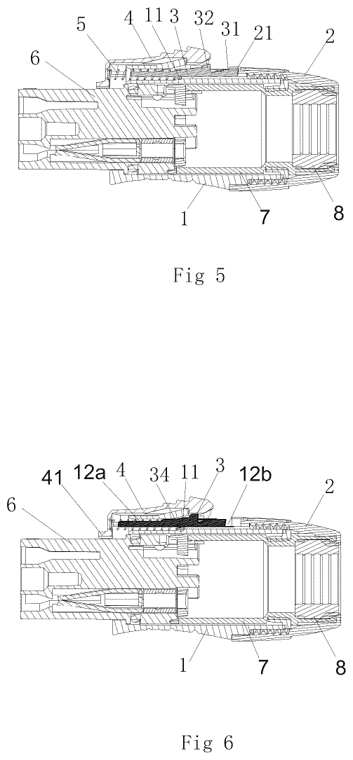

The tail sleeve 2 is aligned with the rear section of the connector housing 1 and is rotationally screwed; after the tail sleeve 2 is screwed to a certain position, the one-way lock catch 31 of the threaded sleeve locking member 3 is meshed with the tooth opening 21 of the tail sleeve 2; in that condition, the tail sleeve 2 can only be screwed down and cannot be unscrewed, as shown in FIG. 5, and the tail sleeve 2 cannot be loosened under the condition of no auxiliary tool.

When the tail sleeve 2 needs to be disassembled, a tool is used for supporting the supporting block 32 of the threaded sleeve locking member 3. The threaded sleeve locking member 3 is pushed forward, and the threaded sleeve locking member 3 is separated from the tail sleeve 2. When the tail sleeve 2 is pushed to the spigot 11, the locking point 34 of the threaded sleeve locking member 3 is matched with the spigot 11 to be locked, the threaded sleeve locking member 3 is positioned where the spigot 11 is arranged, as shown in FIG. 6. When the tail sleeve 2 is disassembled and assembled, the tool is not required to be always supported on the threaded sleeve locking member 3 so that operation becomes convenient.

When the threaded sleeve locking member 3 needs to be reset, the key 4 is slid backwards, and the threaded sleeve locking member 3 moves backwards under the pushing of the key 4 and is separated from the spigot 11. Under the action of the spring 5, the threaded sleeve locking member 3 resets and is meshed and locked with the tooth opening 21 of the tail sleeve 2 again.

The foregoing are merely embodiments of the present invention, and it will be apparent to those skilled in the art that modifications and variations can be made without departing from the technical principle of the present invention, and these modifications and variations should also be regarded as within the scope of the invention.

What is claimed is:

1. A connector plug, comprising:
a connector housing and a tail housing, wherein a rear end of the connector housing connects to the tail housing via threads on the tail housing, an upper surface of the connector housing is provided with a threaded sleeve locking member matched with a tail sleeve, the upper surface of the connector housing is provided with a mounting slot hole for the threaded sleeve locking member to stay in and slide back and forth, a front side of the tail sleeve is provided with a tooth opening along a circumference of the tail sleeve, a rear end of the threaded sleeve locking member is provided with a one-way lock catch that is meshed with the tooth opening and enables the tail sleeve to rotate only in one direction and be fastened with the connector housing, and an elastic piece is arranged in the mounting slot hole to enable the threaded sleeve locking member to maintain a backward movement trend to lock the tail sleeve.

2. The connector plug according to claim 1, wherein a spigot is arranged in the mounting slot hole, a locking point of the threaded sleeve locking member matched with the spigot is convexly arranged on a lower surface of the threaded sleeve locking member, when the locking point of the threaded sleeve locking member is matched with the spigot for locking, the threaded sleeve locking member is separated from the tail sleeve, and a key capable of separating and resetting the threaded sleeve locking member from the spigot is arranged above the threaded sleeve locking member by the connector housing.

3. The connector plug according to claim 2, wherein the threaded sleeve locking member is in a bar shape, a key can be arranged above the threaded sleeve locking member in a front-back limiting sliding manner, a one-way lock catch at the rear end of the threaded sleeve locking member extends out of the key and is positioned at the front side of the external thread of the connector housing, and the elastic piece is supported between the front end of the threaded sleeve locking member and an inner wall of the key, so that the threaded sleeve locking member maintains the backward movement trend and is meshed with the tail sleeve.

4. The connector plug according to claim 3, wherein the mounting slot hole comprises a bar slot or a bar hole or a combination thereof.

5. The connector plug according to claim 4, wherein a front portion of the mounting slot hole is a bar hole, and a rear portion of the mounting slot hole is a bar groove.

6. The connector plug according to claim 5, wherein a front end of the key is a locking piece which cooperates with a socket locked groove of connector, and an internal surface of a top part of the key has a direction spout which cooperates with a locking block that is located above the bar hole of the connector housing to prevent it from slipping.

7. The connector plug according to claim 3, wherein the one-way lock catch is a ratchet-shaped back-off structure, and the tooth opening at the front end of the inner wall of the tail sleeve includes a correspondingly matched triangular structure, an upper surface of the threaded sleeve locking member is convexly provided with a supporting block for the threaded sleeve locking member to be pushed to move forward on the front side of the one-way lock catch.

8. The connector plug according to claim 7, wherein the upper surface of the threaded sleeve locking member is equipped with a concave surface behind the supporting block, and is configured with a three-dimensional forward-pushing arrow mark on the concave surface.

9. The connector plug according to claim 2, wherein a longitudinal section of the spigot is triangular, a longitudinal section of the locking point of the lower surface of the threaded sleeve locking member is inverted triangular, and when the locking point of the threaded sleeve locking member is matched with the spigot, the rear end of the threaded sleeve locking member is disengaged from the front end of the tooth opening of the tail sleeve.

10. The connector plug according to claim 1, wherein the tooth opening is disposed on the inner wall of the tail sleeve and the front part of the internal thread.

11. The connector plug according to claim 2, wherein the tooth opening is disposed on the inner wall of the tail sleeve and the front part of the internal thread.

12. The connector plug according to claim 3, wherein the tooth opening is disposed on the inner wall of the tail sleeve and the front part of the internal thread.

13. The connector plug according to claim 8, wherein the tooth opening is disposed on the inner wall of the tail sleeve and the front part of the internal thread.
